(19) United States
(12) Patent Application Publication
(10) Pub. No.: US 2007/0239085 A1
(43) Pub. Date: Oct. 11, 2007

(54) SHOCKWAVE TREATMENT APPARATUS CARRIED ON A STAND UNIT WITH STOWING CAPACITY

(76) Inventors: Jens Fehre, Hausen (DE); Markus Lanski, Furth (DE); Matthias Mahler, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/687,071

(22) Filed: Mar. 16, 2007

(30) Foreign Application Priority Data
Mar. 16, 2006 (DE) 10 2006 012 228.3

(51) Int. Cl. A61H 1/00

(52) U.S. Cl. 601/4

(57) ABSTRACT

A shockwave treatment apparatus has a shockwave head that emits shockwaves during a shockwave treatment, the shockwave head being arranged on a movable mounting device and supported via the mounting device on a stand unit exhibiting a top side, and having a closable stowage unit. The stowage unit has a cover unit at least partially forming the top side of the stand unit, and at least one guidance means is provided on the stand unit for displacement of the cover unit with a vertical and/or a horizontal movement component relative to the stand unit. Such a stand unit of a shockwave treatment apparatus ensures a secure storage and stowage of objects and is fashioned in a space-saving manner

### BACKGROUND OF THE INVENTION

1. Field of the Invention

The present invention concerns a shockwave treatment apparatus of the type having: a shockwave head that emits shockwaves during a shockwave treatment, whereby the shockwave head being arranged on a movable mounting device and is supported by the mounting device on a stand having a sealable stowage unit.

2. Description of the Prior Art

Treatment or therapy of an examination subject by means of shockwaves is used in several fields of modern medicine. For example, shockwave treatments are used in orthopedics and in lithotripsy, i.e. disintegration of calculi such as gallstones, urinary calculi and kidney stones. Another field of use for shockwave treatments is pain therapy. The shockwaves used are bound longitudinal waves that propagate in a medium, such as acoustic waves in the ultrasonic frequency range. Today extracorporeal shockwave therapy (ESWT) and extracorporeal shockwave lithotripsy (ESWL) are frequently used. The shockwaves are generated by a (normally electro-acoustic) transducer in the shockwave head, are injected into a water reservoir (likewise located in the shockwave head) and from there are conducted into the examination subject by means of a coupling agent. In the water reservoir of the shockwave head the shockwaves are combined by a lens (often made from plastic) onto a focus at a position that coincides with the position of the point or zone to be treated in the examination subject.

Depending on the treatment to be implemented on the examination subject, different energies are introduced or applied per time unit in the examination subject by means of the shockwaves. For lithotripsy, shockwaves with high energy are injected into the examination subject in order to disintegrate the structures (for example urinary calculi or kidney stones) located in the focus. Significantly lower energies are used in pain therapy. The goal of such therapy is to achieve, by means of the shockwaves, a compressive loading and tensile loading of the painful tissue in order to stimulate the metabolism at these points and to alleviate pain. An orthopedic application in which the employed energies of the shockwaves lie between those of the lithotriptic application and the pain therapy application is, for example, tendinosis calcarea. This is an attempt to remove calcium deposits in the shoulder joint in order to improve the mobility of the shoulder.

A stationary or movable shockwave treatment apparatus is used for implementation of a shockwave treatment. This shockwave treatment apparatus has a stand or base unit, a mounting device, and a shockwave head supported on the stand unit by the mounting device. The mounting device normally has a number of mounting elements that can be rotated and possibly displaced relative to one another. The position of the shockwave head can be changed in a wide spatial range and the shockwave head can thereby be flexibly adjusted to the requirements of the treatment, for example as an under-table shockwave head or over-table shockwave head. The focus of the shockwave treatment apparatus is normally placed at the treatment point of the examination subject. The treatment point is normally determined by means of imaging ultrasound or x-ray imaging and the examination subject and/or the shockwave treatment apparatus are correspondingly positioned and aligned using the examinations.

A therapy device for treatment of an organism with focused acoustic waves is known from DE 41 35 177 A1, this therapy device having a source of focused acoustic waves as well as a coupling arrangement for introduction of the acoustic waves into the organism to be treated. A disadvantage of this known therapy device is that no storage and/or stowage possibilities are provided at the therapy device that are usable for secure storage or stowing of equipment or supplies required by the medical personnel or by a patient.

A system for image-supported shockwave treatment is disclosed in DE 10 2004 005 A1. This system has a shockwave head and a support device for a shockwave head that is arranged at the free end of an arm connected at its fixed end to the support device. Also in this stationary system there is no designated storage compatibility or designated stowage space in order to stow equipment or supplies required by the medical personnel.

From the brochure “Dornier Compact Sigma” from Dornier MedTech (available on the Internet at the URL address http:/www.dornier.com/americas/english_gb/products/lithotripters/compactSigma/brochure.htm), a modular lithotripter is additionally disclosed that has a stowage unit in the form of a conventional drawer. The disadvantage of the disclosed stowage unit is that the entire stowage unit is moved upon being opened, such that the contents of the stowage unit experience an acceleration and the danger of a damage to the contents of the stowage unit exits. Furthermore, opening of the stowage unit can only be implemented manually, such that a controlled, time-consuming action by personnel is always required in order to open the stowage unit.

### SUMMARY OF THE INVENTION

An object of the present invention is to provide a shockwave treatment apparatus of the type described above, having a stand unit that ensures a secure storage and stowing of objects and is fashioned in a space-saving manner.

The object is achieved by a shockwave treatment apparatus according to the invention wherein the stowage device is a cover unit that at least partially forms the top of the stand unit, and wherein at least one guidance structure is provided on the stand unit that allows displacement of the cover unit with a vertical and/or a horizontal movement component relative to the stand unit.

Compared to conventional stowage units (such as, for instance, those known from the prior art described above), the storage capacity in or on the shockwave treatment apparatus can be increased by the inventive stowage unit. This is achieved by the cover unit at least partially enclosing the storage space and exhibiting multiple functionalities. The guidance structure can be realized in versatile ways in the framework of the invention, for example as a rail guide.

In an embodiment of the invention the cover unit is fashioned as one part. A rigid body thus can be realized that can be displaced particularly simply by tensile force or pressing force. Casting methods, injection molding methods or deep drawing methods, for example, are suitable for the production of the cover unit, so the work steps for production of the cover unit can be reduced. Furthermore, the guidance of the displacement can be enabled by a simple guidance structure. The cover unit can be made transparent or non-transparent A transparent cover unit allows a view into the storage space contained in the stowage unit, so a fast evaluation of the contents can ensue without opening the stowage unit. A cover unit that is nontransparent directly exhibits the advantage that the stowage space of the stowage unit is not visible to third parties. For example, documents with confidential content (for instance patient records) can then be placed in the stowage unit.

In another embodiment of the invention the cover unit is fashioned as an essentially horizontal stowage unit, i.e., a tray device. In addition to insulating the of a stowage space of the stowage unit from the environment, the cover unit of the stowage unit serves a further function, namely as an easily accessible, simple and secure storage possibility for objects (for example positioning equipment for the localization of the treatment zone). The displacement of the cover unit directed by the guidance structure ensues such that, although the stowage unit changes its position (i.e. its location) during the displacement, it does not change its spatial bearing (i.e. its alignment in space). The tray device is therefore arranged essentially horizontal during the entire displacement such that objects stored on the tray device do not slip under normal circumstances. Upon opening the stowage device by displacement of the cover unit, objects located on the tray device are displaced as well, but they are securely supported at all times. The tray device can be adapted to the requirements of the treatment to be implemented on an examination subject. The tray device, for example, can provide components for secure and, if applicable, sterile containment of medical instruments or therapy supplies. The tray device advantageously exhibits a broad, non-slip tray surface.

In a further embodiment of the invention, the cover unit has a raised edge. The raised edge of the cover unit provides a number of advantages. In principle, only one edge can be raised, or a number of edges of the cover unit can be raised. The raising of multiple edges is advantageous given the design of the cover unit as a tray device. Should stored objects slide onto the tray device by a horizontal relative acceleration of the object toward the tray device, the raised edge prevents the object from falling off the tray device. The raised edges thus serve as a slide stop. A raised edge additionally has the advantage that it can be used as a grip for manual displacement of the cover unit against the stand unit. The need for an additional grip for displacement of the cover unit is thereby avoided, which saves costs and achieves a largest possible secure tray surface area. Furthermore, the grip can be integrated into the overall molding of the stowage device or the cover unit by, for example, being generated as well during the manufacture of the cover unit, for example in a casting method.

In another embodiment of the invention, a displacement (opening) resistance that must be overcome is provided at least for the displacement of the cover unit from a closed state into an opened state of the stowage unit. The displacement resistance can be adjusted with regard to different physical variables. For example, with regard to the position of the cover unit relative to the stand unit, the resistance can be adjusted (varied) dependent on the speed with which the cover unit is displaced relative to the stand unit, or the force which is applied to close the cover unit This avoids the stand device from being inadvertently opened, is closed too quickly, or the like. This increases the security for the objects placed in the stowage space of the stowage unit and for the objects supported (resting) on the tray device of the stowage unit.

In a further embodiment of the invention the cover unit can be displaced in a motorized manner. The medical personnel thus can simply open the cover unit in spite of other activity (for example holding medical instruments). An operating device can be provided for this which, upon actuation or operation by the medical personnel, causes the activation of a drive device that displaces the cover unit relative to the stand unit. The cover unit can be closed again by repeat actuation of the operating device. A controlled opening and closing of the stowage unit is thus possible without the medical personnel having to control the displacement. The concentration of the medical personnel thus can remain with the examination subject to a greater degree than in the case of a manual operation of the cover unit.

In a further embodiment of the invention the cover unit can be set (fixed) in an intermediate position between the closed state and a completely opened state. A high degree of flexibility for access to the stowage space and to the tray device thus is achieved. The setting can ensue by a setting control or simply by the friction force between cover unit and the guidance structure. The setting control can be a stopping connection whose retention force can be adjusted if applicable.

In a further embodiment of the invention the stowage unit can be removed from the stand unit. A modular concept for the shockwave treatment apparatus is thereby enabled. After removal of the stowage unit, for example, an input/output device or other devices required for the treatment can be placed at the position formerly occupied by the stowage unit. This increases the usage flexibility of the entire shockwave treatment apparatus.

In a further embodiment of the invention, the stowage unit can be sealed. By sealing the stowage unit (meaning that the cover device can essentially no longer be displaced relative to the stand unit due to the presence of a sealing device), medical agents can, for example, be carried along directly to the shockwave treatment apparatus. Possible medical agents are, for example, contrast agent for the localization of the treatment point in the examination subject. A further increase of the security for such medical agents can be achieved by mountings that can be arranged Inside the stowage unit. For instance, a bottle holder configured, for example, to retain bottles or ampules containing contrast agent can be provided.

In a further embodiment of the invention, the stand unit is supported on roller elements. The entire shockwave treatment apparatus thus can be moved. This is frequently required since a shockwave treatment apparatus is more often used in combination with a further medical device, for example an x-ray device. It may be necessary to change the positions of the further medical device and the shockwave treatment apparatus relative to one another in order, for example, to achieve a better accessibility to the examination subject. This can be achieved easily when the shockwave treatment apparatus is supported on roller elements. Roller elements can be fashioned in different ways, for instance as cylindrical rollers, balls etc.

In a further embodiment of the invention, at least one part of a stand grip of the stand unit is fashioned such that the cover unit can be directed by the stand grip. The guide structure attached in addition to the stand grip that can be reduced in terms of their dimensions, which saves on costs, and the operation of the cover unit can be undertaken at least in part by the stand grip or at least one of its parts. The stand grip thus serves not only as a gripping region for displacement of the entire stand unit but also as a guidance structure for the cover unit. For this purpose, it is normally necessary to arrange at least one part of the stand grip on the stand such that this part encompasses a similar angle or the same angle as the surface normal of the cover unit as the guidance structure provided independent of the cover unit. In a special case, the entire guidance structure for direction of the cover unit can be fashioned as part of the stand grip.

The above object also is achieved by a stand unit for a medical treatment apparatus with a top side with a closable stowage unit with a mounting device is supported on the stand unit, with a medical treatment apparatus arranged on the mounting device. The stowage unit has a cover unit forming at least part of the top side of the stand unit; and at least one guidance structure is provided on the stand unit for displacement of the cover unit with a vertical and/or a horizontal movement component relative to the stand unit. The stowage unit can also be provided for stand units that are not components of a shockwave treatment apparatus. This in particular concerns movable and immobile x-ray devices and further medical treatment apparatuses which, due to their compact and space-saving design, exhibit a lack of stowage space and possible tray surfaces.

### DESCRIPTION OF THE DRAWINGS

FIG. 1 is a side view of an inventive shockwave treatment apparatus in a closed state.

FIG. 2 is a side view of an inventive shockwave treatment apparatus in an opened state.

FIG. 3 is a plan view of an inventive shockwave treatment apparatus in a closed state.

FIG. 4 is a plan view of an inventive shockwave treatment apparatus in an opened state.

### DESCRIPTION OF THE PREFERRED EMBODIMENTS

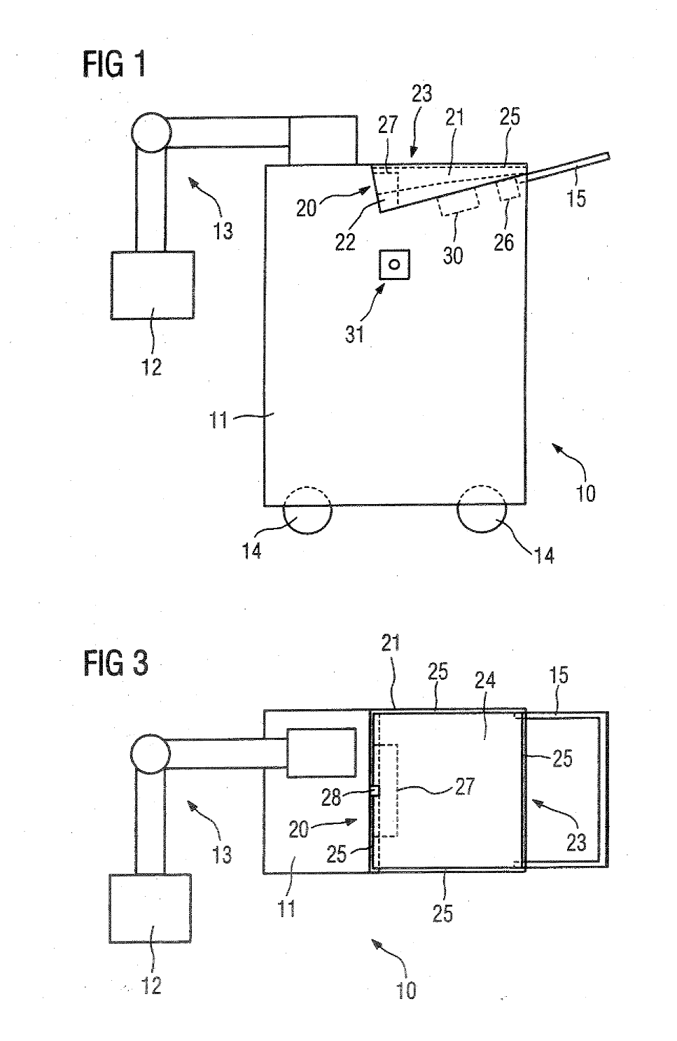

FIG. 1 through FIG. 4 show a shockwave treatment apparatus 10 that has a stand unit 11, a shockwave head 12 and a mounting device 13 connecting the shockwave head 12 with the stand unit 11. The mounting device 13 has a number of retaining elements that are located opposite one another and such that they can move relative to the stand unit 11. The position of the shockwave head 12 thus can be adapted to the requirements of a shockwave treatment.

Furthermore, the stand unit 11 is supported on roller elements 14 such that it is mobile. The stand unit 11 of the shockwave device 10 is normally fashioned small and in a space-saving manner since the movable shockwave treatment apparatus 10 is frequently combined with an x-ray apparatus (not shown), for instance a C-arm x-ray apparatus, in order to localize a treatment point of an examination subject. The use of a number of medical-technical apparatuses at an examination subject can limit the movement possibilities of all of the apparatuses due to the size of the respective other apparatus or, respectively, apparatuses. It is sought to reduce such limitations by, among other things, designating the stand unit or stand units associated with the medical apparatuses are optimally compact and in a space-saving manner.

The stand unit 11 of the shockwave treatment device 10 has a multi-functioning stowage unit 20 that is well adapted to the concept of a compact stand unit 11. The stowage unit 20 has a cover unit 21 which at least partially forms the top side of the stand unit 11. The cover unit 21 is supported at the stand unit 11 on two guide rails 22 integrated into the side walls of the stand unit 11. A positive fit connection of the cover unit 21 with the guide rails 22 is thus achieved. Additional guidance components are not needed due to the positive fit connection, which entails cost advantages. However, at least one metallic guide rail, for example between the stand unit 11 and the cover unit 21, can also be provided as a guide structure. This possibly represents a more costly embodiment of the guide structure, but exhibits other technical advantages, for example generation of an adjustable displacement resistance for the displacement of the cover unit 21 relative to the stand unit 11.

The cover unit 21 is guided by the guide rails 22 and can be displaced relative to the stand unit 11. The stowage space of the stowage unit 20, the stowage space being enclosed by the cover unit 21 in the closed state, is thereby uncovered. The displacement of the cover unit 21 relative to the stand unit 21 can ensue in steps or continuously. For example, the guide rails 22 can exhibit a wave profile for a stepped displacement of the cover unit. The stowage unit 20 can additionally assume a number of opened states which differ in the position of the cover unit 21 that is effected by the displacement. In the exemplary embodiment the guide rails 22 enclose an angle of approximately 60 degrees with the surface normal that is perpendicular to the surface of the stand unit 11, or cover unit 21. The enclosed angle is, however, not limited to 60 degrees. In principle encompassed angles from 0 degrees to 90 degrees between guide rails 22 and surface normal are possible.

The top side of the cover unit 21 of the stowage unit 20 is fashioned as a tray device 23 in the exemplary embodiment, so the cover unit 21 has a further functionality. In the closed state of the stowage unit 20 the cover unit 21 encloses the stowage space and isolates it from the environment. Additionally, the cover unit 21 can be used as a tray device 23. The tray device 23 has one or more non-skid sterilizeable tray surfaces 24. The tray device 23 is bounded by edges 25 that are raised in the horizontal direction in order to prevent sliding of a deposited object from the tray device 23, for example in the case of a sudden stoppage of the stand unit 11 moving on roller elements 14. An inner subdivision of the tray device 23 into a number of tray surfaces 24 by separation devices (not shown) can additionally be provided.

Those edges 25 that are perpendicular to the larger (in terms of magnitude) displacement direction component are advantageously fashioned as grips. The grips can be executed in various ways. The larger (in terms of magnitude) displacement direction component is dependent on the encompassed angle of the guide rails 22 and the surface normal of the cover unit 21 or, respectively, of the stand unit 11. Given an encompassed angle of 45 degrees, the horizontal displacement component is equal (in terms of magnitude) to the vertical displacement component. By fashioning at least one edge of the cover unit as a grip, at least one gripping region for personnel is provided in a particularly simple and cost-effective manner for displacement of the cover unit 21.

A further advantage that results from the arrangement of the guide rails 22 (shown in FIG. 1 through FIG. 4) relative to the surface normal of the top side of the stand unit 11 is in that the tray device 23 is adjustable in terms of height, such that the vertical position component of the tray device 23 can be adapted within a certain range to the size of the personnel using the shockwave treatment apparatus 10. This advantage occurs for all angles enclosed by the surface normal of the cover unit 21 or of the stand unit 11 with the guide rails 22 that are not equal to 90 degrees.

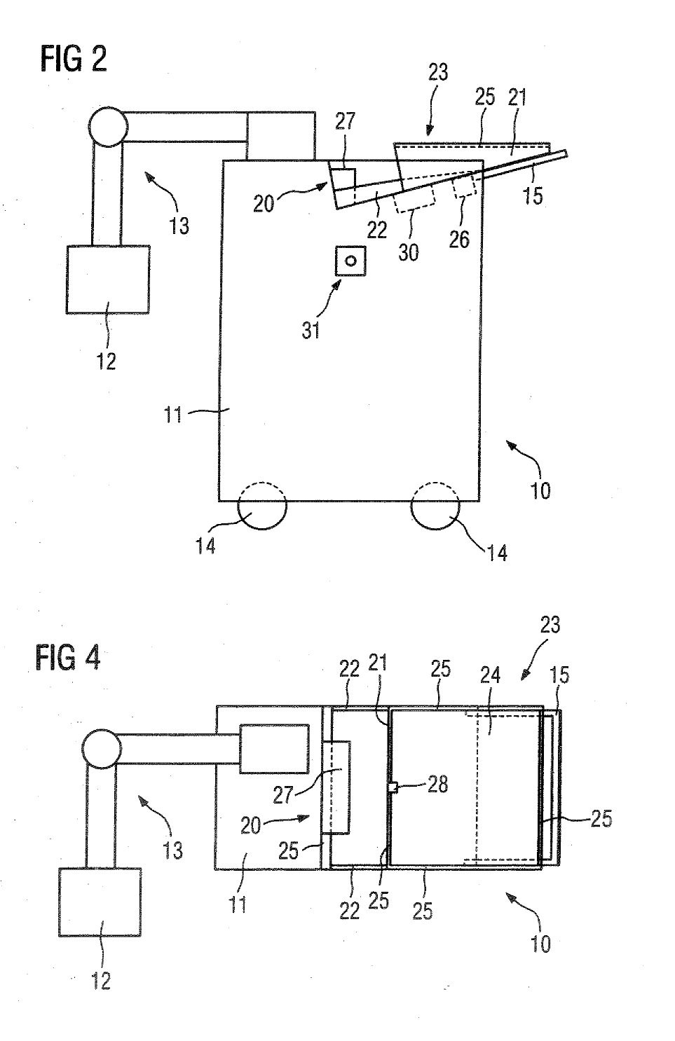

FIG. 1 and FIG. 2 also show a mechanical resistance 26 arranged on the stand unit 11, the mechanical resistance 26 in the exemplary embodiment being a spring element and effecting a displacement resistance upon the displacement of the cover unit 21 of the stowage unit 20 from the closed state to an opened state. Other designs of the mechanical resistance 26 are also possible as well as other arrangements of the guide rails 22 or arrangements of the stowage unit 20. The generation of the displacement resistance can also be enabled by an electrical and/or electromagnetic device. The mechanical resistance 26 prevents an unintentional opening and/or closing of the stowage unit 20 in that a displacement resistance to be overcome is generated by means of the mechanical resistance 26. In addition to the mechanical resistance, fixing elements can be provided. The fixing elements can also be identical with or combined with the resistance means 26. The fixing elements serve to retain a specific position of the cover unit 21 (in particular given an opened state of the stowage unit 20) relative to the stand unit 11. The cover unit 21 is, for example, manually directed from the closed state into an (partially) opened state. If the cover unit 21 should remain in this position over a longer span of time, fixing elements for fixing or stopping the cover unit in this position can be provided. Fixing elements are also provided when the friction force of the cover unit 21 and guide rail 22 (which friction force is dependent on the angle enclosed by the surface normal of the top side of the stand unit 11 and the guide rails 22) allows arresting of the cover unit in a specific position.

The stowage unit 20 additionally has a sealing device 28 in the form of a lock [bolt; latch]. Sensitive (with regard to the data protection) documents or medicines can be placed in the stowage unit 20 and be protected from an unauthorized access. The lock can be electrically or mechanically locked and unlocked by a number combination. Other means for sealing the stowage unit 20 can possibly also be provided, for example a fingerprint scanner. Mechanical keys that would otherwise possibly have to be produced in high numbers are thereby not needed. The stowage unit 20 can have a subdivision 27 of the stowage space, for example for documents (such as, for instance, the operating instructions of the shockwave treatment apparatus 10) as well as required therapy agents and/or medicines.

The displacement of the cover unit 21 relative to the stand unit 11 can also be effected in a motorized manner. For this a drive unit 30 can be provided which displaces the cover unit 21 along the guide rails 22. The displacement can be initiated via a control device 31 and also can be adjusted by the control device 31. The control device 31, for example, can be fashioned as a button recessed into the stand unit 11, with the movement or displacement of the cover unit 21 ensuing for the duration of the button press by the personnel. The recessing of the button prevents an unintended triggering of the displacement of the cover unit 21. The manual contact with the tray device 23 is reduced by the use of a drive device 30 in connection with a control device 31 and spreading germs on the tray device 23 on which, for example, medical instruments can be placed, is also reduced. A control device can possibly be provided so that the displacement of the cover unit 21 can be controlled. This is particularly appropriate when a control device is already provided (for example for controlling the shockwave head 12) and the control of the cover unit 21 represents only a further stored control process in the control device and thus incurs no additional costs.

Although modifications and changes may be suggested by those skilled in the art, it is the intention of the inventors to embody within the patent warranted hereon all changes and modifications as reasonably and properly come within the scope of their contribution to the art.

We claim as our invention:

1. A shockwave treatment apparatus comprising:
a shockwave head that emits shockwaves during a shockwave treatment;
a stand unit having a top side;
a mounting device attached to said stand unit that mounts said shockwave head on said stand unit and allows movable adjustment of said shockwave head relative to said stand unit; and
a stowage unit in said stand unit, said stowage unit comprising a cover unit that at least partially forms said top side of said stand unit, and said stand unit comprising at least one guidance structure therein that interacts with said cover unit to allow displacement of said cover unit with at least one of a vertical movement component and a horizontal movement component relative to said stand unit.

2. A shockwave treatment apparatus as claimed in claim 1 wherein said cover unit consists of one piece.

3. A shockwave treatment apparatus as claimed in claim 1 wherein said cover unit consists of one piece.

4. A shockwave treatment apparatus as claimed in claim 1 wherein said cover unit forms a substantially horizontally oriented tray device.

5. A shockwave treatment apparatus as claimed in claim 2 wherein said cover unit has at least one raised edge.

6. A shockwave treatment apparatus as claimed in claim 1 wherein said cover unit is displaceable between a close state and an open state, and wherein said stowage unit comprises a mechanical displacement resistance that interacts with said cover unit and that must be overcome to displace said cover unit from said closed state to said open state.

7. A shockwave treatment apparatus as claimed in claim 1 comprising a motor in said stand unit that interacts with said cover unit to displace said cover unit.

8. A shockwave treatment apparatus as claimed in claim 1 wherein said cover unit is displaceable between a closed state and a completely opened state, and wherein said stowage unit comprises a fixing element that allows said cover unit to be fixed in an intermediate position between said closed state and said completely opened state.

9. A shockwave treatment apparatus as claimed in claim 1 wherein said stowage unit is completely removable from said stand unit.

10. A shockwave treatment apparatus as claimed in claim 1 comprising an activatable sealing unit that, when activated, seals said stowage unit in said stand unit.

11. A shockwave treatment apparatus as claimed in claim 1 wherein said stand unit comprises roller elements at a bottom thereof, making said stand unit mobile.

12. A shockwave treatment apparatus as claimed in claim 11 wherein said stand unit comprises a stand grip allowing manual movement of said stand unit, and wherein at least a portion of said stand grip interacts with said cover unit.
